(19) United States
(12) Patent Application Publication
(10) Pub. No.: US 2011/0211277 A1
(43) Pub. Date: Sep. 1, 2011

(54) DETECTING CIRCUIT AND INSPECTING APPARATUS

(76) Inventors: Takuma NISHIMOTO, Fujisawa (JP); Masami Makuuchi, Yokohama (JP); Yoshihiro Sakurai, Hadano (JP); Kunihito Higa, Isehara (JP)

(21) Appl. No.: 13/021,846

(22) Filed: Feb. 7, 2011

(30) Foreign Application Priority Data
Feb. 26, 2010 (JP) 2010-041275

(51) Int. Cl. G11B 21/02; G05B 1/02

(52) U.S. Cl. 360/75; 318/608; G9B/21.003

(57) ABSTRACT

A detecting circuit, which can detect plural types of servo signals, including a cosine/sine value detector for sampling a servo signal supplied from an inspected object and thereby obtaining a cosine value and a sine value, an amplitude/phase detector for obtaining at least amplitude information and phase information on the basis of the cosine value and the sine value obtained by the cosine/sine value detector, and a servo selector/position detector for selecting a servo scheme of the inspected object and detecting a position of the inspected object on the basis of the amplitude information and the phase information obtained by the amplitude/phase detector.

### INCORPORATION BY REFERENCE

The present application claims priority from Japanese application JP2010-041275 filed on Feb. 26, 2010, the content of which is hereby incorporated by reference into this application.

### BACKGROUND OF THE INVENTION

The present invention relates to a detecting circuit for controlling a magnetic head and an inspecting apparatus.

For controlling a magnetic head which is a principal function part of a magnetic disk drive, it is necessary to detect servo information recorded on a disk surface and obtain a servo signal.

As a conventional art, “a position signal demodulation method comprising: performing digital sampling on first and second servo burst signals read by a head with a frequency which is at least twice a servo burst signal frequency; respectively, calculating a cosine coefficient and a sine coefficient of a predetermined signal component by using a digital sampling value for each of the first and second servo burst signals; calculating pieces of amplitude information of the first and second servo burst signals by calculating square roots of square-sum of the cosine coefficient and the sine coefficient, respectively, and calculating a difference between the pieces of amplitude information of the first and second burst signals” is disclosed in a claim of JP-A-2005-50547.

In abstract of JP-A-7-287949 (corresponding to U.S. Pat. No. 5,694,265, Kosugi et al), “a disk apparatus in which a clock generating means 102 is set in synchronism with a peak detection of a servo timing read-out signal detected by a peak detecting means, and is reset with detection of a zero cross of a phase servo pattern read-out signal by a zero cross detecting means to make a duty pulse, and a position signal is made by integrating the duty pulse” is disclosed.

In a claim of U.S. Pat. No. 6,426,845 B1, “a method comprising steps of: generating a normal demodulating signal that is asynchronous with a read signal; generating a quadrature demodulating signal that is ninety degrees out of phase with the normal demodulating signal; multiplying the normal demodulating signal by the read signal to produce a normal position signal; multiplying the quadrature demodulating signal by the read signal to produce a quadrature position signal; and producing a position error magnitude and a position error direction based on the normal position signal and the quadrature position signal” is disclosed.

### SUMMARY OF THE INVENTION

The present inventors have studied the inspecting apparatuses disclosed in the above-described preceding technical documents. As a result, the following has been elucidated.

The servo scheme differs according to the kind of the magnetic disk drive or magnetic disk. For exercising servo control in the inspecting apparatus, a channel control IC having a servo signal detection function corresponding to various magnetic disks is needed. For a single inspecting apparatus to cope with magnetic disks of a plurality of kinds, therefore, it is necessary to obtain a channel control IC corresponding to the magnetic disks and remodel the inspecting apparatus. This results in a problem that the manufacturing cost of the inspecting apparatus increases and consequently the cost of the magnetic disk and the magnetic head, and in addition the cost of the magnetic disk drive increases.

When the method described in JP-A-2005-50547 is used, sine waves and cosine waves are obtained by DFT (Discrete Fourier Transform) arithmetic operation. Therefore, a predetermined number of sampling data are needed, and it is necessary to make the sampling frequency high or lengthen the sampling term of the servo signal. Therefore, it becomes necessary to use an expensive fast A/D converter or only a disk which generates a long servo signal can be coped with.

In addition, the DFT arithmetic operation has a problem that real time processing becomes difficult because an enormously long calculation time is needed.

The present invention has been made in view of problems described heretofore, and an object thereof is to provide an inexpensive inspecting apparatus by making it possible for one servo signal detector to conduct servo signal detection with respect to servo signals of a plurality of kinds.

The above-described object and other objects and novel features of the present invention will be elucidated by the description made herein and accompanying drawings.

Outlines of representative aspects of the invention disclosed herein are as follows:

(1) A detecting circuit including a cosine/sine value detector for sampling a servo signal supplied from an inspected object and thereby obtaining a cosine value and a sine value, an amplitude/phase detector for obtaining at least amplitude information and phase information on the basis of the cosine value and the sine value obtained by the cosine/sine value detector, and a servo selector/position detector for selecting a servo scheme of the inspected object and detecting a position of the inspected object on the basis of the amplitude information and the phase information obtained by the amplitude/phase detector.

(2) The detecting circuit described in (1), wherein the servo selector/position detector includes a selector for selecting the servo scheme of the inspected object and a position information detector for detecting the position of the inspected object, and the position information detector includes a plurality of different detectors to cope with the servo scheme selected by the selector.

According to the present invention, an inspecting apparatus capable of conducting servo signal detection in one servo signal detector with respect to servo signals of a plurality of kinds.

Other objects, features and advantages of the invention will become apparent from the following description of the embodiments of the invention taken in conjunction with the accompanying drawings.

### BRIEF DESCRIPTION OF THE DRAWINGS

FIG. 1 is a configuration diagram of an embodiment 1 of a servo signal detector according to the present invention;

FIG. 2 is a diagram for explaining a servo signal detection flow in an embodiment 1 of a servo signal detector according to the present invention;

FIG. 3 is a diagram for explaining a principle of processing for acquiring phase information, in a phase detector in an embodiment 1 of a servo signal detector according to the present invention;

FIG. 4 is a diagram showing an example of a configuration of an amplitude/phase detector in an embodiment 1 of a servo signal detector according to the present invention;

FIG. 5 is a diagram showing an example of a configuration of a servo selector/position detector in an embodiment 1 of a servo signal detector according to the present invention;

FIG. 6 is a configuration diagram of an embodiment 2 of a servo signal detector according to the present invention;

FIG. 7 is a configuration diagram of an embodiment 3 of a servo signal detector according to the present invention;

FIG. 8 is a diagram for explaining an operation of a data aligning circuit in an embodiment 3 of a servo signal detector according to the present invention;

FIG. 9 is a configuration diagram of an embodiment 4 of a servo signal detector according to the present invention;

FIG. 10 is a configuration diagram of an inspecting apparatus including a servo signal detector according to the present invention;

FIG. 11 is a diagram showing an example of a conventional inspecting apparatus; and

FIG. 12 is a diagram for explaining a magnetic disk which is an inspected object.

### DESCRIPTION OF THE EMBODIMENTS

Hereafter, embodiments of the present invention will be described in detail with reference to the drawings. Throughout all diagrams for explaining the embodiments, the same members are denoted by like reference characters in principle, and repetitive description thereof will be omitted.

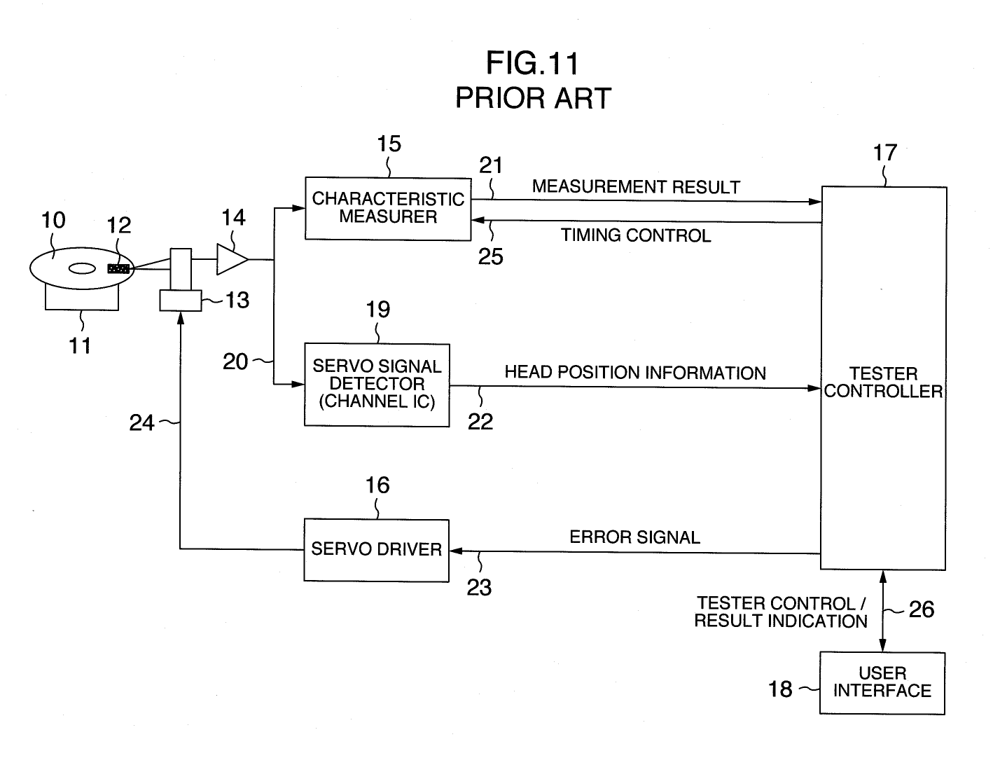

First, a configuration of a conventional magnetic disk inspecting apparatus will be described. FIG. 11 is a configuration diagram showing an example of the conventional magnetic disk inspecting apparatus.

The conventional magnetic disk inspecting apparatus shown in FIG. 11 includes a spin stand 11 for mounting a disk 10 which is an inspected object thereon, an R/W head 12 for writing and reading on the disk 10, a stage 13 for supporting the R/W head 12, a servo driver 16 for transmitting a control signal to control movement of the stage 13, an R/W amplifier 14 for obtaining a read-out signal 20 via the R/W head 12, a characteristic measurer 15 for transmitting the read-out signal obtained from the R/W amplifier 14, a servo signal detector (channel IC) 19, a tester controller 17 which conducts signal transmission and reception with the characteristic measurer 15, the servo signal detector (channel IC) 19 and the servo driver 16, and a user interface 18 which conducts transmission of a tester control/defect indication signal with the test controller 17.

Hereafter, an outline of operation in the conventional magnetic disk inspecting apparatus (hereafter referred to as “inspecting apparatus”) will be described.

In the conventional inspecting apparatus, a user of the inspecting apparatus specifies an inspecting operation of the inspecting apparatus via the user interface 18. The user interface 18 conducts arithmetic operation of operation setting information for each part in the inspecting apparatus by using an incorporated control program (not illustrated), and sets predetermined setting data in the tester controller 17 via a tester control/result indication signal 26. The tester controller 17 controls an operation mode of the whole tester such as a write/read mode and operations of respective parts of the tester in accordance with data which is set. In the write mode, data for test is written onto the disk 10 rotated by the spin stand 11 via the R/W head 12 on the basis of data generated by a data generator (not illustrated). In the read mode, a read-out signal 20 is obtained by conducting readout and amplification from the disk 10 rotated by the spin stand 11 via the R/W head 12 and the R/W amplifier 14 and the characteristic measurer 15 measures predetermined signal characteristic from the read-out signal 20 at predetermined timing in accordance with a timing control signal 25 supplied from the tester controller 17, and obtains a measurement result 21. The tester controller 17 conducts predetermined arithmetic operation processing on the measurement result 21, obtains an inspection result, and displays the inspection result via the user interface 18 by using the tester control/result indication signal 26 on the basis of the inspection result.

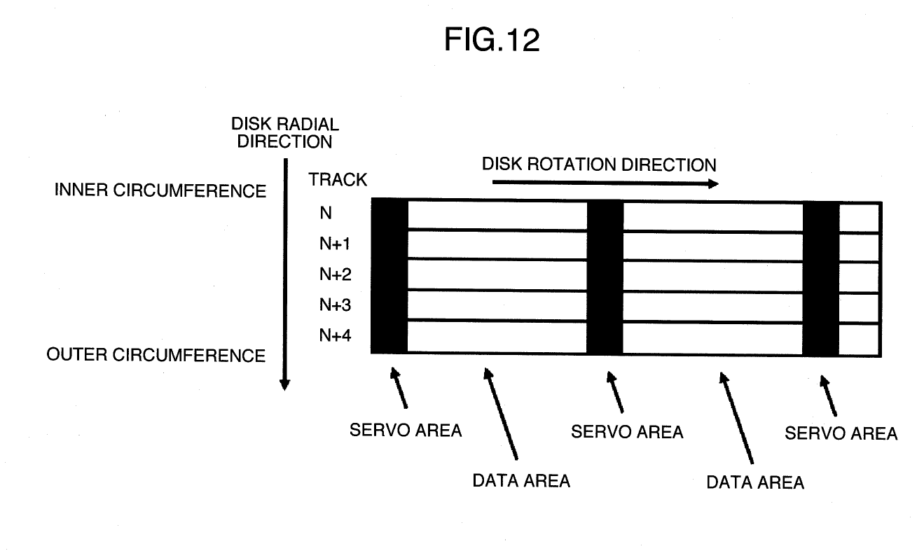

FIG. 12 is a diagram for explaining a magnetic disk which is an inspected object. As shown in FIG. 12, a plurality of data tracks each having servo areas and data areas are arranged on the disk 10. It is necessary to exercise track control to dispose the R/W head 12 on an inspected object track. Furthermore, when conducting data writing/reading on the disk 10 subjected to rotation control, it is necessary to exercise servo control in parallel in order to suppress track deviation caused by a surface swing or eccentricity. In the inspecting apparatus, the servo signal detector 19 extracts head position information 22 which means a deviation of the magnetic head from the track center, on the basis of a signal (hereafter referred to as “servo signal”) which is the read-out signal 20 supplied from the disk 10 and which corresponds to servo areas shown in FIG. 12. The tester controller 19 calculates error information between a current track position of the R/W head 12 on the disk 10 and a measured object track, on the basis of the head position information 22, and outputs an error signal 23. The servo driver 16 generates a stage control signal 24 on the basis of the error signal 23, and exercises position control of the stage 13. As a result, the above-described track control and servo control are exercised in parallel.

### Embodiment 1

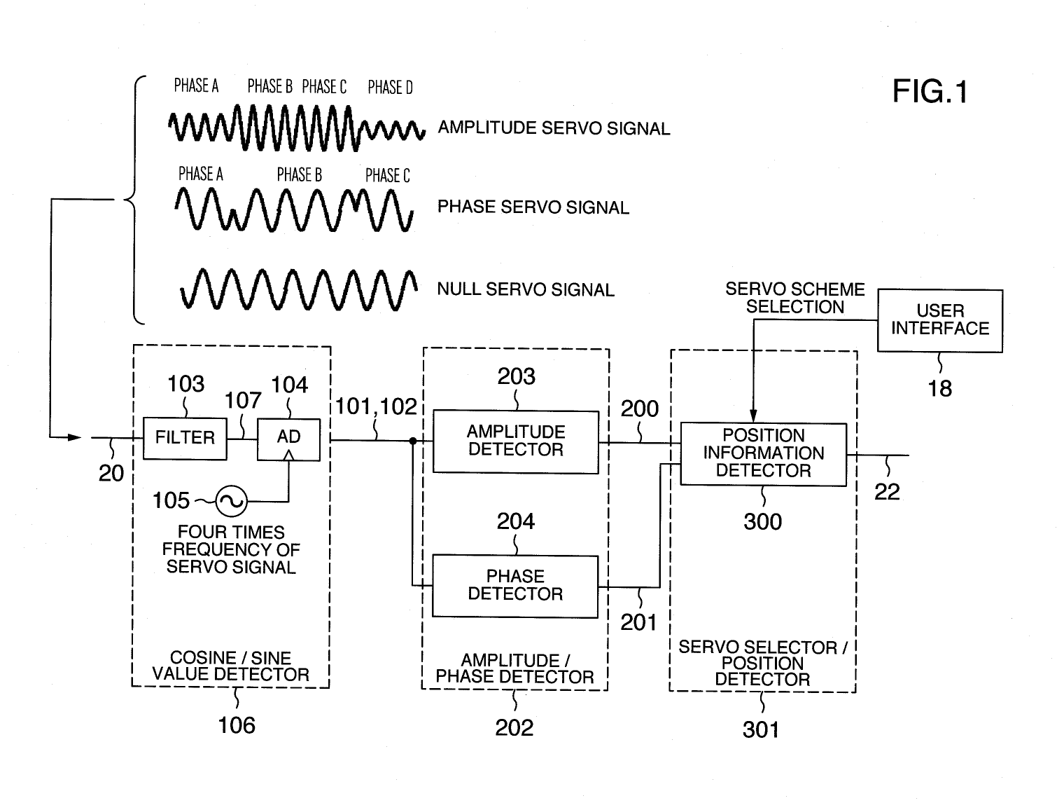

An example of an embodiment of a servo signal detector according to the present invention will now be described with reference to FIGS. 1 to 5 and FIG. 10.

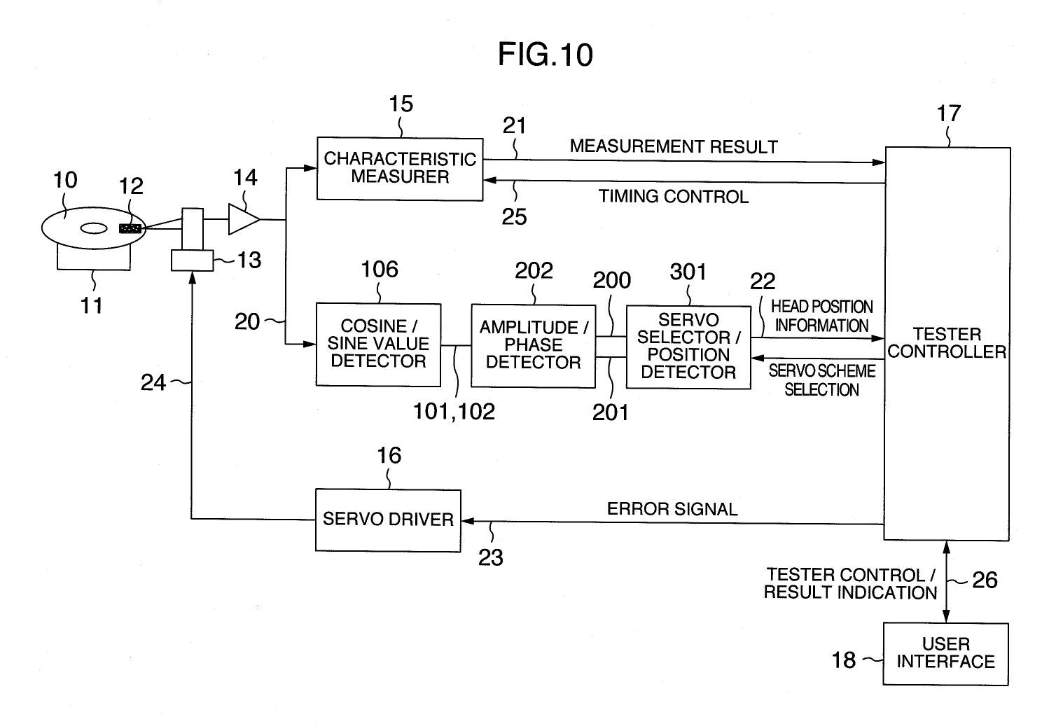

FIG. 10 is a configuration diagram of an inspecting apparatus including a servo signal detector according to the present invention. The inspecting apparatus including a servo signal detector according to the present invention is configured to include a cosine/sine value detector 106, an amplitude/phase detector 202, and a servo selector/position detector 301 as the servo signal detector 19 in the conventional inspecting apparatus shown in FIG. 11. Before reading the servo signal 20 from the R/W head 12, the inspecting apparatus including the servo signal detector according to the present invention inputs data of servo scheme selection supplied from the user interface 18 to the servo selector/position detector 301 via the tester controller 17, and previously selects a predetermined position information arithmetic operator provided for each servo system. The inspecting apparatus including a servo signal detector according to the present invention has a feature that the servo signal 20 read out from the R/W head 12 is then input to the cosine/sine value detector 106 and the head position information 22 which is an arithmetic operation result obtained from the servo selector/position detector 301 is output to the tester controller 17.

Hereafter, an embodiment 1 of the servo signal detector according to the present invention will be described with reference to FIG. 1.

The servo signal detector in the embodiment 1 is configured to include the cosine/sine value detector 106, the amplitude/phase detector 202, and the servo selector/position detector 301. The cosine/sine value detector 106 is configured to include a filter 103, an A/D converter 104 and a PLL 105. The amplitude/phase detector 202 is configured to include an amplitude detector 203 and a phase detector 204. The servo selector/position detector 301 is configured to include a position information detector 300.

The servo signal input to the filter 103 is one of (1) the amplitude servo signal, in which amplitude ratios between phases indicates head position information, (2) the phase servo signal, in which phase differences between phases indicates head position information and (3) the null servo signal, in which an amplitude and a phase difference indicate head position information.

The filter 103 extracts a fundamental wave component of the servo signal which is a sine wave by limiting a band of the servo signal 20. The PLL 105 generates a sampling frequency which is four times the frequency of the servo signal 40. The A/D converter 104 samples a servo signal 107 which is converted to a sine wave by using the quadruple frequency generated by the PLL 105. Then, the amplitude detector 203 acquires amplitude information 200 from output data 101 of the A/D converter 104. The phase detector 204 acquires phase information 201 from the output data 101 of the A/D converter 104. Then, the position information detector 300 selects a servo scheme and acquires head position information 22 by using the amplitude information 200 and the phase information 201 which are output respectively from the amplitude detector 203 and the phase detector 204 and an output of the user interface 18.

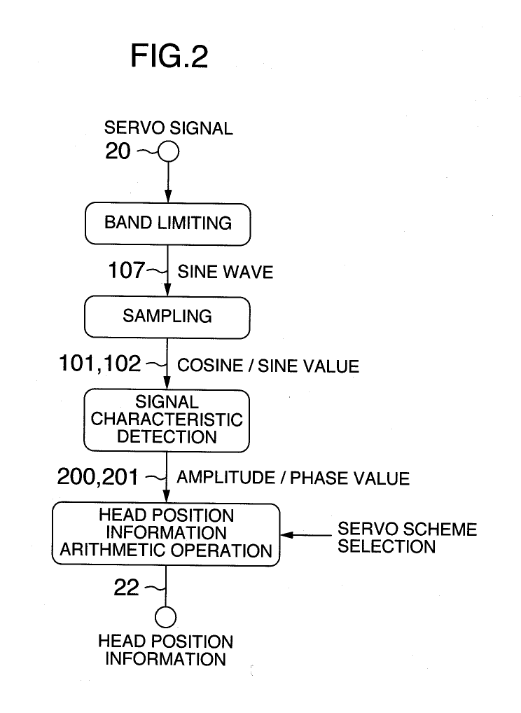

FIG. 2 is a diagram for explaining a servo signal detection flow in the embodiment 1 of the servo signal detector according to the present invention. A flow for acquiring the head position information 22 will now be described with reference to FIG. 2.

First, a fundamental wave component of the servo signal which is a sine wave is extracted by conducting band limiting on the servo signal 20 read out from the magnetic head 12 in the filter 103. By sampling the sine wave servo signal 107 with the quadruple frequency, the phase difference between consecutive sampling data becomes π/2 and data which satisfy the relation between the sine value 102 and the cosine value 101 are acquired. Then, the amplitude information 200 and the phase information 201 of the servo signal 20 are acquired on the basis of the sine value 102 and the cosine value 101. Denoting kth sampling data by D[k] and the next data by D[k+1], A which is the amplitude information 200 is calculated by the following arithmetic operation.

A=\sqrt{D[k]²+D[k+1]²} (Expression 1)

The amplitude information 200 can be obtained by adding up squares of two consecutive sampling data and calculating a square root of the resultant sum.

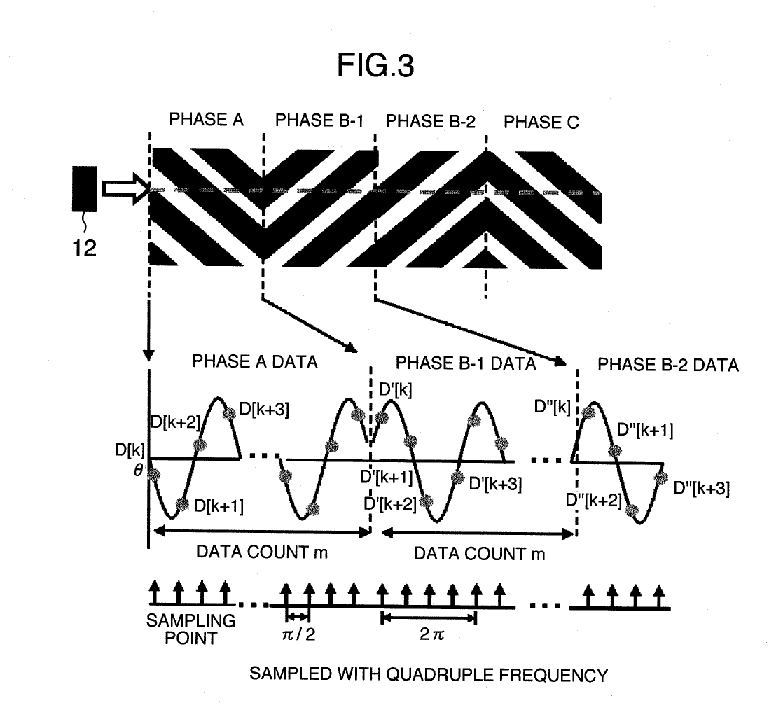

FIG. 3 is a diagram for explaining a principle of processing for acquiring phase information, in the phase detector in the embodiment 1 of the servo signal detector according to the present invention.

FIG. 3 shows a servo pattern of a phase servo formed of three phases, i.e., phase A, phase B and phase C, a sine wave signal 107 which is a fundamental wave component of the servo signal obtained by conducting band limiting on the servo signal 20 generated from the servo pattern with the filter 103 and extracting the fundamental wave component, and sampling points obtained by sampling the sine wave signal 107 with the quadruple frequency. The phase information 201 is a phase difference between signals generated at respective phases. In the servo pattern having the three-phase configuration as shown in FIG. 3, the phase B is divided into two phases, i.e., phase B-1 and phase B-2, and two phase differences between the phase A and the phase B-1 and between the phase B-2 and the phase C are acquired. Hereafter, the arithmetic operator will be described.

Denoting kth sampling data in the phase A by D[k], the next data by D[k+1], kth sampling data in the phase B-1 by D′[k], the next data by D′[k+1], the following expression is obtained.

D[k]=A sin(θ+φ₁), D[k+1]=A cos(θ+φ₁)

D′[k]=A sin(θ+φ₂), D′[k+1]=A cos(θ+φ₂) (Expression 2)

Here, φ₁ and φ₂ are initial phases of servo signals generated in the phase A and the phase B-1, respectively. Therefore, the phase difference between the phase A and the phase B-1 can be found as a sine value by executing the following arithmetic operation.

Tₛ=A² sin(φ₁−φ₂)≈D[k]·D′[k+1]−D′[k]·D[k+1] (Expression 3)

When finding the phase difference as a cosine value, the following arithmetic operation is used.

T_{c}=A² cos(φ₁−φ₂)≈D[k]·D′[k]+D[k+1]·D′[k+1] (Expression 4)

The phase difference between the phase B-2 and the phase C can also be obtained in a similar procedure.

If the sampling frequency deviates from four times the frequency of the servo signal, then a deviation of the sampling phase is generated and an accumulated phase error accumulated every sampling is contained in the arithmetic operation result. Therefore, it is necessary to correct the accumulated phase error. In that case, the accumulated phase error can be corrected by noting that the phase B-1 and the phase B-2 are originally the same phase and using the phase difference detected value of B-1 and B-2. Hereafter, correction of phase information errors caused by the sampling frequency deviation will be described.

If an accumulated phase error is contained, then kth and (k+1)-st sampling data of the phase A D[k] and D[k+1], kth and (k+1)-st sampling data of the phase B-1 D′[k] and D′[k+1], and kth and (k+1)-st sampling data of the phase B-2 D″[k] and D″[k+1] are represented by the following expression.

D[k]=A sin(θ+φ₁) D[k+1]=A cos(θ+φ₁+Δφ)

D′[k]=A sin(θ+φ₂+mΔφ) D′[k+1]=A cos(θ+φ₂+(m+1)Δφ)

D″[k]=A sin(θ+φ₂+2mΔφ) D″[k+1]=A cos(θ+φ₂+(2m+1)Δφ) (Expression 5)

Here, m is the number of samples in each phase, and Δφ is an error quantity between a sampling phase at the time when the sampling frequency deviates from four times the frequency of the servo signal and the ideal sampling phase 90 degrees. As the number m of samples increases, the phase error contained in data increases.

In the same way, phase differences Ts and Tc respectively of the phase A and phase B-1 are found by Expression 6.

Tₛ=A² sin(φ₁−φ₂−m·Δφ)≈D[k]·D′[k+1]−D′[k]·D[k+1],

T_{c}=A² cos(φ₁−φ₂−m·Δφ)≈D[k]·D′[k]+D[k+1]·D′[k+1] (Expression 6)

In the state in which the accumulated phase deviation m·Δφ is contained, the phase differences of the phase A and the phase B-1 are found. Then, phase differences Tcm and Tsm respectively of the phase B-1 and the phase B-2 are found according to the same procedure as the above-described procedure in order to correct the sampling phase deviation.

T_{cm}=A² cos(m·Δφ)≈D′[k]·D″[k]+D′[k+1]·D″[k+1],

Tₛₘ=A² sin(m·Δφ)≈D″[k]·D′[k+1]−D′[k]·D″[k+1] (Expression 7)

The accumulated phase error of sampling can be corrected by executing the following arithmetic operation using Ts, Tc, Tcm and Tsm obtained as described heretofore.

A⁴ cos(φ₁−φ₂)=T_{c}·T_{cm}−Tₛ·Tₛₘ

A⁴ sin(φ₁−φ₂)=Tₛ·T_{cm}+T_{c}·Tₛₘ (Expression 8)

As described heretofore, the sine value and the cosine value having the phase differences of the phase A and the phase B-1 corrected in the accumulated phase error are obtained. Phase differences of the phase B-2 and the phase C after the accumulated phase error correction are obtained in the same way.

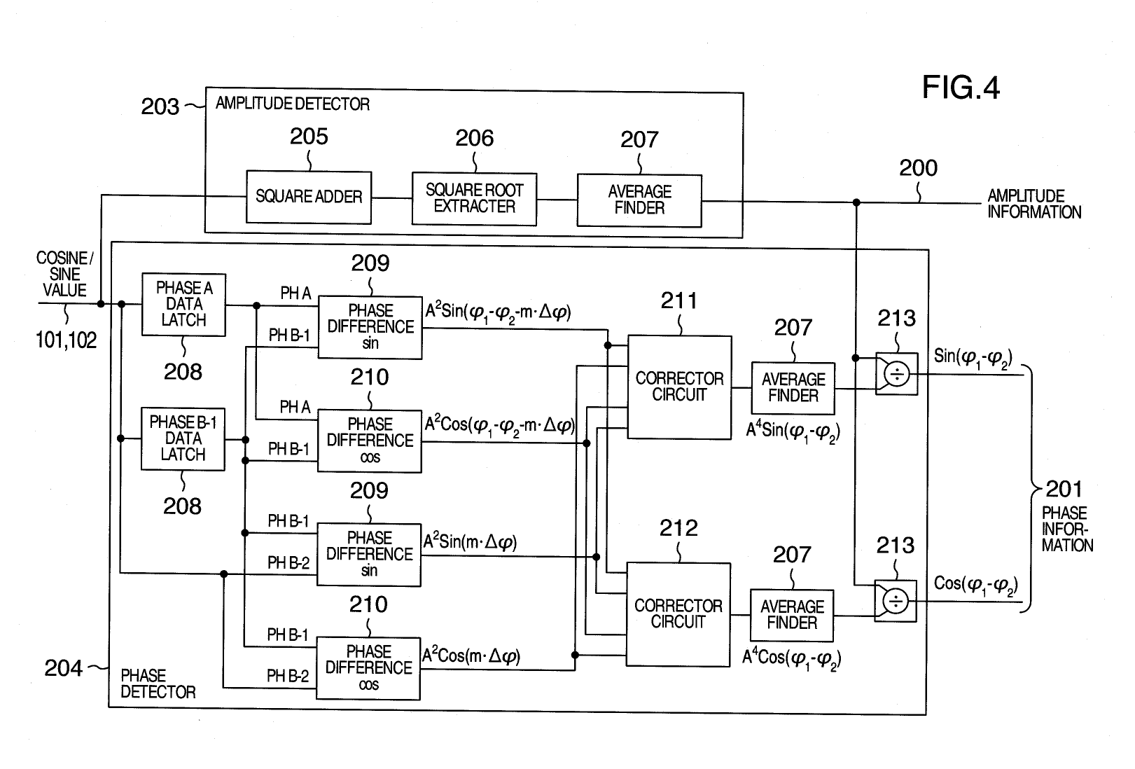

FIG. 4 is a diagram showing an example of a configuration of an amplitude/phase detector in the embodiment 1 of the servo signal detector according to the present invention. The amplitude/phase detector 202 is configured to include the amplitude detector 203 and the phase detector 204. The amplitude detector 203 is configured to include a square adder circuit 205, a square root extractor circuit 206 and an average finder circuit 207. The phase detector 204 is configured to include data latch circuits 208, sine value output phase difference arithmetic operator circuits 209, cosine value output phase difference arithmetic operator circuits 210, corrector circuits 211 and 212, average finder circuits 207 and dividers 213.

In the amplitude detector 203, the square adder circuit 205 adds up squares of two consecutive sampling data and the square root extractor circuit 206 calculates a square root. Then, the average finder circuit 207 averages data while the servo signal 20 is being input and thereby acquires the amplitude information 200.

In the phase detector 204, phase A sampling data and phase B-1 sampling data are stored in the phase A data latch circuit 208 and the phase B-1 data latch circuit 208, respectively. At timing of receiving transferred phase B-2 sampling data, the sine value output phase difference arithmetic operator circuits 209 and the cosine value output phase difference arithmetic operator circuits 210 conduct phase information arithmetic operation, and the corrector circuits 211 and 212 start corrective arithmetic operations. The average finder circuits 207 average outputs of the corrector circuits 211 and 212, respectively. Finally, the dividers 213 divide phase values after the correction by the amplitude obtained at the same timing by the arithmetic operation, and thereby obtain standardized phase information 201.

The servo selector/position detector 301 executes predetermined arithmetic operations of respective servo schemes on the basis of the amplitude information 200 and the phase information 201 obtained as described heretofore and calculates head position information 22.

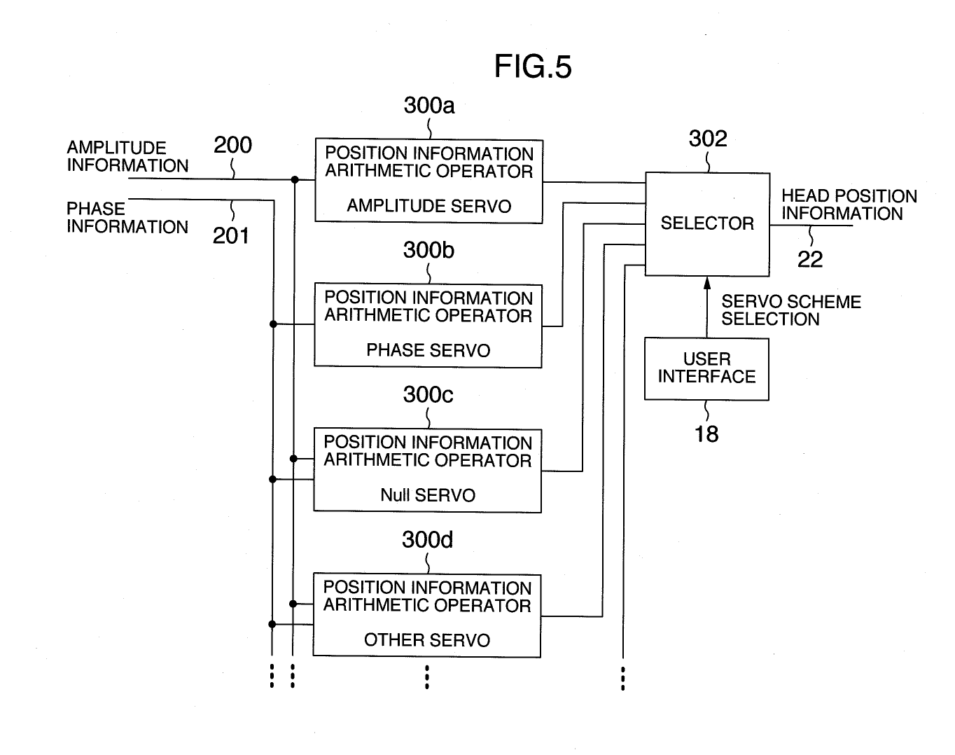

FIG. 5 is a diagram showing an example of a configuration of the servo selector/position detector in the embodiment 1 of the servo signal detector according to the present invention. The servo selector/position detector 301 is configured to include position information detectors (arithmetic operators) 300 and a selector 302, which selects a servo scheme and outputs an arithmetic operation result.

The position information detectors (arithmetic operators) 300 include a position information arithmetic operator amplitude servo 300a which receives the amplitude information 200, a position information arithmetic operator phase servo 300b which receives the phase information 201, a position information arithmetic operator null servo 300c which receives the amplitude information 200 and the phase information 201, and a position information arithmetic operator other servo 300d which receives the amplitude information 200 and the phase information 201. The selector 302 receives transmission data from respective servos and selects a servo scheme.

The position information detectors (arithmetic operators) 300 are provided for respective servo schemes. Each of the position information detectors (arithmetic operators) 300 executes predetermined arithmetic operations on the amplitude information 200 and the phase information 201 and obtains head position information 22.

The selector 302 receives a selected servo scheme selection signal from the user interface 18, selects head position information 22, and outputs the head position information 22.

Also in the null servo scheme in which the movement direction of the magnetic head is acquired on the basis of whether the phase difference between a signal in a burst area serving as the reference and a signal in a burst area which indicates position information of the magnetic head is 0 degree or 180 degrees and an error quantity is acquired on the basis of amplitude information, it becomes possible to acquire head position information by obtaining amplitude information and phase information by using means described heretofore and conducting predetermined arithmetic operation processing in the null servo position information arithmetic operator 300c. As long as head position information is acquired on the basis of amplitude information and phase information of the servo signal in the servo scheme, therefore, it becomes possible to arbitrarily conduct detection by providing arithmetic operation means for acquiring head position information in the servo selector/position detector 301. When coping with magnetic disks of a plurality of kinds, therefore, it becomes unnecessary to procure a channel control IC corresponding to a magnetic disk and remodel the inspecting apparatus to cope with it. As a result, it becomes possible for a single inspecting apparatus to cope with magnetic disks of a plurality of kinds.

As heretofore described, the present embodiment can cope with the null servo with the amplitude servo and the phase servo combined and the amplitude information and the phase information combined. Furthermore, as long as the head position information is obtained from the amplitude information and the phase information in the servo scheme, arbitrary detection becomes possible.

Furthermore, it is possible to obtain a sine wave and a cosine wave from one period of the servo signal by sampling the servo signal converted to a sine wave by band limiting of the filter, with a quadruple frequency. As a result, the sampling frequency can be made low as compared with the method disclosed in JP-A-2005-50547. Furthermore, in the case where the DFT arithmetic operation is conducted, only a disk which generates a servo signal having at least a predetermined length can be coped with. On the other hand, it becomes possible for the embodiment to cope with a disk which generates a shorter servo signal.

Furthermore, the calculation quantity is decreased remarkably as compared with the DFT arithmetic operation. This results in an effect that calculation in a short time becomes possible and real time processing is facilitated.

### Embodiment 2

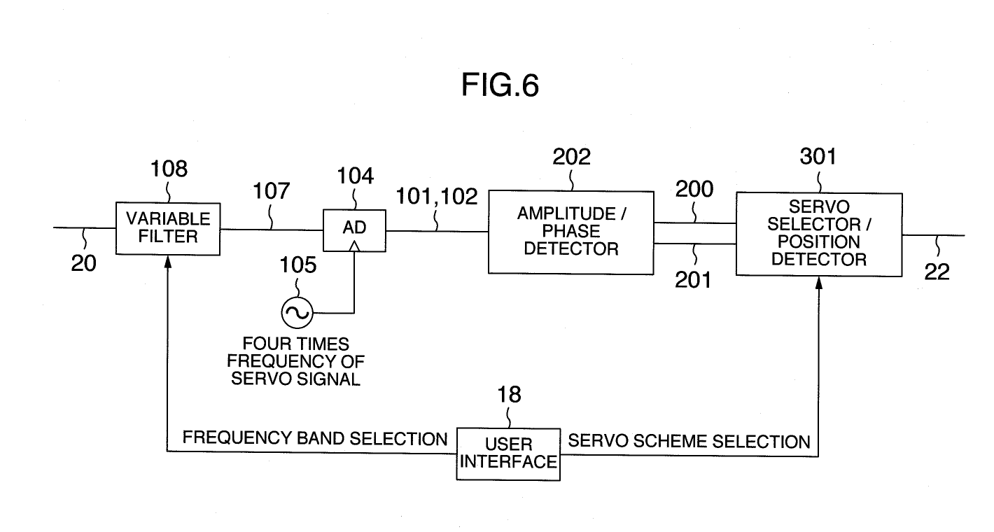

An example of an embodiment of a servo signal detector according to the present invention will now be described with reference to FIG. 6.

FIG. 6 is a configuration diagram of an embodiment 2 of the servo signal detector according to the present invention. The present embodiment relates to a servo signal detector for coping with servo signals which differ in frequency bands.

The servo signal detector according to the embodiment 2 has a feature that it includes the PLL 105, the A/D converter 104, the amplitude/phase detector 202, and the servo selector/position detector 301 which are components of the embodiment 1, as its basic configuration and it uses a variable filter 108 as the filter.

In the present embodiment, the frequency band to be limited in the variable filter 108 is changed according to a frequency band selection signal by inputting the frequency band selection signal of the servo signal 20 from the user interface 18 to the variable filter 108. As a result, it becomes possible to acquire head position information even if the frequency of the servo signal is changed by a change in the kind of the disk 10 or a change in the number of revolutions of the spin stand 11.

### Embodiment 3

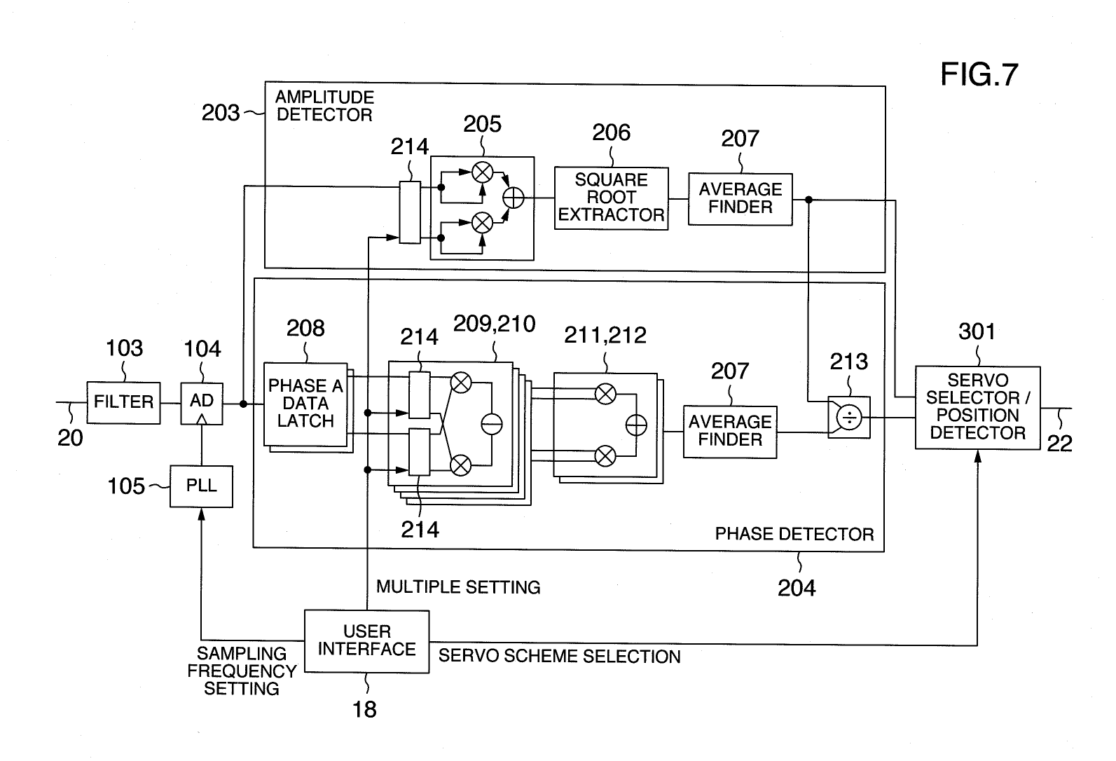

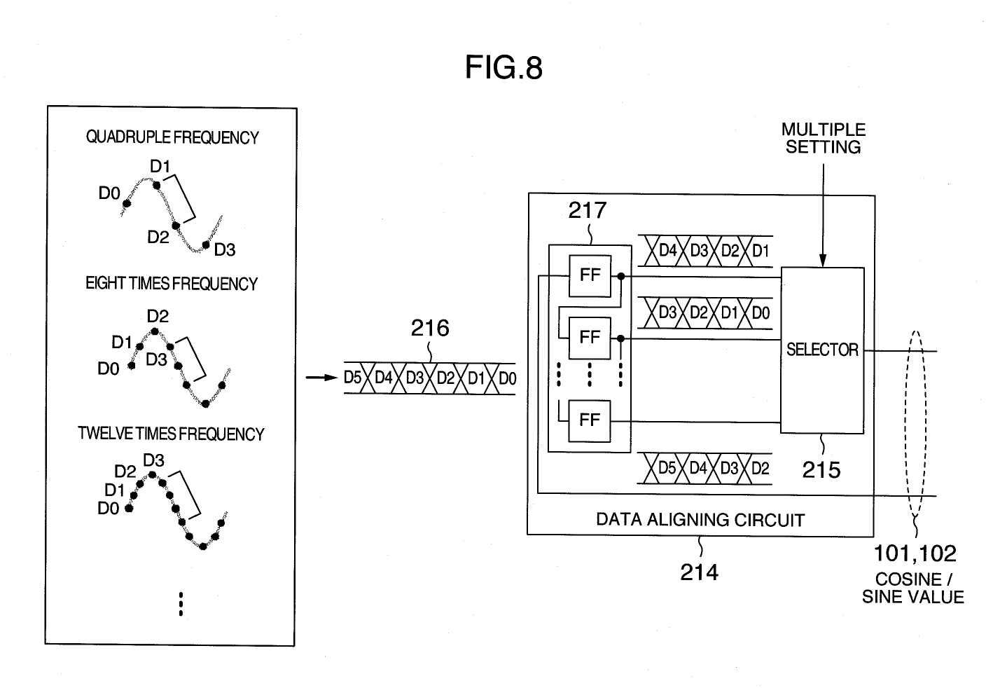

An example of an embodiment of the servo signal detector according to the present invention will now be described with reference to FIG. 7 and FIG. 8.

FIG. 7 is a configuration diagram of an embodiment 3 of the servo signal detector according to the present invention. FIG. 8 is a diagram for explaining an operation of a data aligning circuit in an embodiment 3 of the servo signal detector according to the present invention. In the present embodiment, the detection precision of the head position information 22 is made high by making the sampling frequency high.

The servo signal detector according to the present embodiment 3 has a feature that it includes the filter 103, the PLL 105, the A/D converter 104, the amplitude detector 203, the phase detector 204, and the servo selector/position detector 301 which are components of the embodiment 1, as its basic configuration and it further includes a data aligning circuit 214.

In the present embodiment, a sampling frequency which is an integer times (N times) of a quadruple frequency of the servo signal 20 is generated by the PLL 105 and input to the A/D converter 104 to increase the number of sampling data to N times. In general, if the number of sampling data is increased to N times, then the influence of random noise can be reduced and the detection precision of the signal characteristics can be increased to N̂(1/2) times. (“̂” means a power operator.) If the sampling frequency is increased to 4N times, then data which assume the relation of cosine and sine become, for example, Kth data and (K+N)-th data, and (K+1)-st data and (K+N+1)-st data. In other words, data which assume the relation of cosine and sine become certain data and data located N positions behind the certain data. The examples are shown in FIG. 8. When the sampling frequency is quadruple of the servo signal frequency, that is, N=1, data and the next data are in cosine-sine relation. When the sampling frequency is eight times, that is, N=2, data and the second next data are in cosine-sine relation. When the sampling frequency is twelve times, that is, N=3, data and the third next data are in cosine-sine relation. According to the magnification N which is set in the user interface 18 of FIG. 7, the permutation of data which assume the relation of cosine and sine is changed. The data aligning circuit 214 in the present embodiment executes rearrangement of data according to the multiple N which is set in the user interface to make it possible for the amplitude detector 203 and the phase detector 204 to conduct arithmetic operations.

The data aligning circuit 214 will now be described with reference to FIG. 8. The data aligning circuit 214 is configured to include a delay circuit 217 and a selector 215. Sampling data which is input is split into two, and one is output as it is whereas the other is input to the delay circuit 217. The delay circuit 217 inputs data series obtained by shifting the sampling data one by one to the selector 215. The selector 215 selects and outputs a data series obtained by shifting the sampling data by N positions, in accordance with the multiple N which is set in the user interface. As a result, two data which are output from the data aligning circuit 214 become a combination having the relation of cosine and sine.

As described heretofore, it becomes possible to use a sampling frequency which is 4N (where N is an integer) times the frequency of the servo signal 20. And it becomes possible to make the detection precision of the head position information 22 high owing to the increase of the sampling frequency.

### Embodiment 4

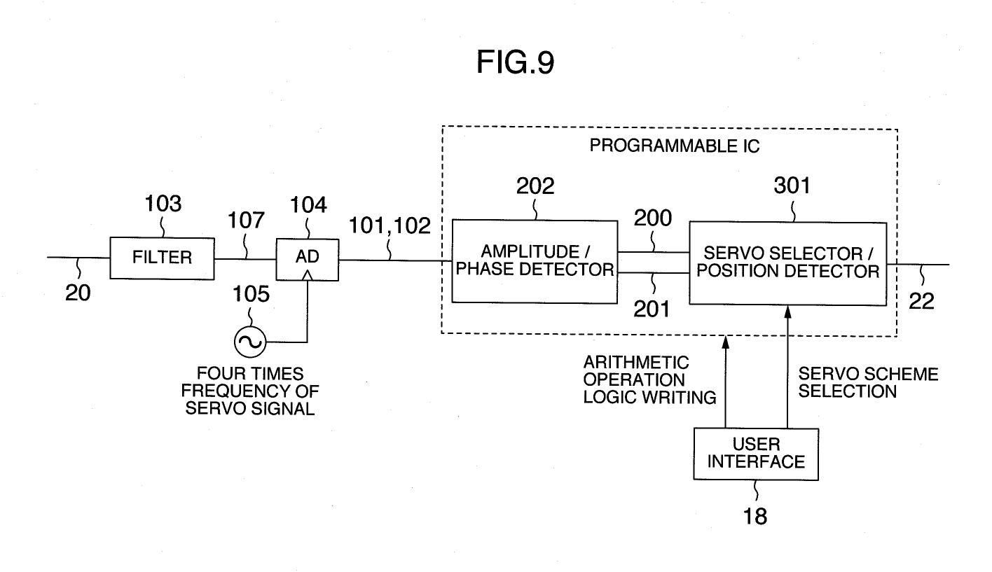

An example of an embodiment of a servo signal detector according to the present invention will now be described with reference to FIG. 9.

FIG. 9 is a configuration diagram of an embodiment 4 of a servo signal detector according to the present invention.

In the present embodiment, a logical arithmetic operation part is formed of a programmable IC such as a FPGA (Field-Programmable Gate Array), a CPLD (Complex Programmable Logic Device) and a DSP (Digital Signal Processor). As a result, it is made possible to cope with a novel servo scheme only by a change of arithmetic operation logical data and reduction of the inspecting apparatus cost can be implemented.

The servo signal detector according to the present embodiment 4 has a feature that it includes the filter 103, the PLL 105, the A/D converter 104, the amplitude/phase detector 202, and the servo selector/position detector 301 which are components of the embodiment 1, as its basic configuration, and the amplitude/phase detector 202 and the servo selector/position detector 301 are formed of a programmable IC such as a FPGA, a CPLD and a DSP.

In the present embodiment, it is possible to cope with a novel servo scheme by conducting only addition or modification on the arithmetic operation logic of the amplitude/phase detector 202 and the servo selector/position detector 301 formed of a programmable IC. As a result, improvement of the inspecting apparatus executed whenever coping with a novel servo scheme can be omitted and the cost of the inspecting apparatus can be reduced.

In the foregoing description, an integer times four has been taken as an example. However, the fundamental thought is not restricted to this. As a matter of course, it is possible to sample the servo signal and select and detect sampling data which can be approximated to an integer times four from sampling data obtained by sampling the servo signal as long as the detection precision is within an allowable range.

Heretofore, invention made by the present inventors has been described specifically with reference to the embodiments. However, the present invention is not restricted to the embodiments, but various changes are possible without departing from the spirit of the present invention.

1. A detecting circuit comprising:
a cosine/sine value detector for sampling a servo signal supplied from an inspected object and thereby obtaining a cosine value and a sine value;
an amplitude/phase detector for obtaining at least amplitude information and phase information on the basis of the cosine value and the sine value obtained by the cosine/sine value detector; and
a servo selector/position detector for selecting a servo scheme of the inspected object and detecting a position of the inspected object, on the basis of the amplitude information and the phase information obtained in the amplitude/phase detector.

2. The detecting circuit according to claim 1, wherein
a signal supplied from the inspected object which is sampled by the cosine/sine value detector is a servo signal, and
a scheme selected by the servo selector/position detector is a servo scheme.

3. The detecting circuit according to claim 1, wherein the inspected object is a magnetic disk.

4. The detecting circuit according to claim 3, wherein the position of the inspected object detected by the servo selector/position detector is a head position of the inspected object.

5. The detecting circuit according to claim 1, wherein
the servo selector/position detector comprises a selector for selecting the servo scheme of the inspected object and a position information detector for detecting the position of the inspected object, and
the position information detector comprises a plurality of different detectors to cope with the servo scheme selected by the selector.

6. The detecting circuit according to claim 5, wherein the plurality of detectors comprise at least a detector corresponding to amplitude servo, a detector corresponding to phase servo, and a detector corresponding to null servo.

7. The detecting circuit according to claim 1, wherein the cosine/sine value detector comprises a filter for conducting band limiting on a signal supplied from the inspected object and extracting a fundamental wave component.

8. The detecting circuit according to claim 7, wherein the cosine/sine value detector further comprises an A/D converter which samples the fundamental wave component extracted by the filter, with a quadruple frequency.

9. The detecting circuit according to claim 7, wherein the filter in the cosine/sine value detector is a variable filter.

10. The detecting circuit according to claim 1, wherein
the amplitude/phase detector comprises an amplitude detector for obtaining amplitude information on the basis of the cosine value and the sine value obtained by the cosine/sine value detector, and a phase detector for obtaining phase information on the basis of the cosine value and the sine value obtained by the cosine/sine value detector, and
each of the amplitude detector and the phase detector comprises a data aligning circuit comprising a delay circuit and a selector.

11. The detecting circuit according to claim 10, wherein the data aligning circuit inputs one of sampling data which is output from the cosine/sine value detector to the delay circuit, then inputs outputs of the delay circuit to the selector in the data aligning circuit, and outputs data shifted according to a sampling frequency in the cosine/sine value detector while outputting the other of the sampling without any delay operation.

12. The detecting circuit according to claim 11, wherein two data which are output from the data aligning circuit have a relation of cosine and sine.

13. The detecting circuit according to claim 1, wherein the amplitude/phase detector and the servo selector/position detector are formed of a programmable IC.

14. The detecting circuit according to claim 13, wherein the programmable IC is a FPGA (Field-Programmable Gate Array), a CPLD (Complex Programmable Logic Device) or a DSP (Digital Signal Processor).

15. An inspecting apparatus comprising:
a detecting circuit according to claim 1;
a head for reading a signal from the inspected object;
a stage for supporting the head;
a tester controller for receiving head position information which is output from the detecting circuit on the basis of the servo signal supplied from the head and transmitting an error control signal; and
a servo driver for receiving the error signal from the tester controller and transmitting a control signal to control the stage.
